(19) United States
(12) Patent Application Publication
(10) Pub. No.: US 2015/0340128 A1
(43) Pub. Date: Nov. 26, 2015

(54) FLAME-RETARDANT ZIPPER SLEEVE FOR WRAPPING AN OPTICAL FIBER CABLE BUNDLE OR AN ELECTRICAL CABLE BUNDLE AND A METHOD OF MAKING THE ZIPPER SLEEVE

(71) Applicant: Avago Technologies General IP (Singapore) Pte. Ltd, Singapore (SG)

(72) Inventor: Chi Keung Lee, Palo Alto, CA (US)

(73) Assignee: Avago Technologies General IP (Singapore) Pte. Ltd, Singapore (SG)

(21) Appl. No.: 14/286,920

(22) Filed: May 23, 2014

(51) Int. Cl. H01B 7/295; A44B 19/56; A44B 19/46; A44B 19/38; A44B 19/34

(52) U.S. Cl. CPC H01B 7/295; A44B 19/38; A44B 19/343; A44B 19/46; A44B 19/56

(57) ABSTRACT

A zipper sleeve is provided that is made entirely or almost entirely of highly flame-retardant meta-aramid material to provide the zipper sleeve with highly flame-retardant characteristics. The zipper teeth rows of the zipper mechanism are attached directly to respective side edges of opposite sides of a sheet of highly flame-retardant material that will be used to make the sleeve. By attaching the zipper teeth rows directly to the meta-aramid material, the process of attaching the teeth can be fully automated, which ensures that the teeth will be precisely aligned. This feature allows a highly flame-retardant zipper sleeve made entirely or almost entirely out of meta-aramid material to be manufactured at relatively low costs and with very high yield.

### TECHNICAL FIELD OF THE INVENTION

The invention relates to a flame-retardant zipper sleeve for wrapping an optical fiber or electrical cable bundle.

### BACKGROUND OF THE INVENTION

Optical fiber cables are used to transmit optical signals between optical transmitters and optical receivers. An optical fiber cable has a single optical fiber or multiple optical fibers encased within a cable jacket. Similarly, electrical cables have a single wire or multiple wires encased within a cable jacket. Cable sleeves are used in a variety of cable management applications to encase bundles of optical fiber or electrical cables along the entire length or along a portion of the length of the bundles.

Cable sleeves are made of a variety of different materials. The cable sleeve that is selected for use in a particular application will be made of a material that is suitable for the application. For example, cable sleeves are typically made of one of the following materials: polyethylene terephthalate (PET); Nylon; Fiberglass; Mylar®; Teflon®; stainless steel; Kevlar®; and Nomex®. These materials provide the sleeves with certain characteristics that make them suitable for particular applications.

For example, cable sleeves made of PET are abrasion resistant and are used in general purpose applications to protect the bundles of cables from being damaged by external objects that might come into physical contact with the cables if the bundles are not encased in the sleeves. As another example, due to the flame-retardant characteristics of Nomex®, cable sleeves that are made of Nomex® are used in applications where risks of flames exist. Nomex® is a flame-retardant, meta-aramid material that was developed by E.I du Pont de Nemours and Company in the 1960s. For example, Nomex meta-aramid fibers are used is the aerospace industry in fuselages, in racing suits used by racers in the auto racing industry, and in suits used by firefighters.

Side-entry cable sleeves are split in the longitudinal direction of the sleeve to allow the sleeve to be secured about the cable bundle at generally any point along the cable bundle run. Side-entry cables sleeves also allow reworking of the cables should the need arise. Side-entry cable sleeves have a variety of different mechanism for securing the sides of the sleeve to one another. Typical securing mechanisms include zippers, hook-and-loop fasteners and buttons.

Optical fiber and electrical cables are often bundled and passed through area-handling spaces in buildings or other structures. There are often fire-safety standards that must be complied with to prevent or at least limit the extent to which smoke and fire can spread along the cables in a plenum or other air-transport space. Although zipper sleeves are available that are made of flame-retardant materials, currently no zipper sleeve is available that is highly flame retardant and that can be manufactured with very high precision at relatively low costs. Accordingly, a need for such a zipper sleeve exists.

### SUMMARY OF THE INVENTION

The invention is directed to a highly flame-retardant zipper sleeve for wrapping a bundle of cables and a method of making the zipper sleeve. The zipper sleeve comprises a sheet of highly flame-retardant material and a zipper mechanism. The sheet has first and second sides, a top, and a bottom. The zipper mechanism has first and second zipper teeth rows that are directly attached to first and second side edges of the first and second sides of the sheet, respectively. The first and second zipper teeth rows have first and second rows of teeth, respectively. The first zipper teeth row has a pin located at a first end thereof. The second zipper teeth row has a retainer box located at a first end thereof. The second zipper teeth row has a slider of the zipper mechanism mechanically coupled thereto via a Y-channel of the slider. The slider is in sliding engagement with the second row of teeth.

In accordance with an embodiment, the zipper sleeve comprises a sheet made mostly or entirely of meta-aramid fibers and a zipper mechanism. The sheet has first and second sides, a top, and a bottom. The zipper mechanism has first and second zipper teeth rows that are directly attached to first and second side edges that are knitted into the first and second sides of the sheet, respectively. The first and second knitted side edges are thicker than the thickness of the sheet. The first and second zipper teeth rows have first and second rows of teeth, respectively. The first zipper teeth row has a pin located at a first end thereof. The second zipper teeth row has a retainer box located at a first end thereof. The second zipper teeth row has a slider of the zipper mechanism mechanically coupled thereto via a Y-channel of the slider. The slider is in sliding engagement with the second row of teeth.

In accordance with an embodiment, the method of making the highly flame-retardant zipper sleeve comprises the following: a sheet of highly flame-retardant material and having first and second sides with first and second side edges, respectively, a top, and a bottom is knitted in a knitting machine; the knitted sheets are then fed into a modified zipper teeth attachment machine; and, in the modified zipper teeth attachment machine, first and second zipper teeth rows of a zipper mechanism are directly attached to the first and second side edges, respectively, of the sheet.

These and other features of the invention will become apparent from the following description, drawings and claims.

### BRIEF DESCRIPTION OF THE DRAWINGS

FIG. 1 illustrates a perspective view of an optical fiber cable bundle wrapped in a zipper sleeve in accordance with an illustrative embodiment.

FIG. 2 illustrates a perspective view of the zipper sleeve shown in FIG. 1 without the optical fiber cable bundle.

FIG. 3 illustrates a perspective view of the zipper sleeve shown in FIG. 2 with the components that make up the zipper mechanism removed.

FIG. 4 illustrates an expanded side plan view of the portion of the zipper sleeve sheet inside of the dashed circle 18 shown in FIG. 3.

FIG. 5 illustrates a flow diagram that demonstrates the method of making the highly flame-retardant zipper sleeve in accordance with an illustrative embodiment.

### DETAILED DESCRIPTION OF AN ILLUSTRATIVE EMBODIMENT

In accordance with illustrative embodiments of the invention, a zipper sleeve is provided that is made entirely or almost entirely of meta-aramid material to provide the zipper sleeve with highly flame-retardant characteristics. In addition, unlike known zipper sleeve manufacturing processes in which separately purchased open-ended zippers are sewn onto the sides of the sheets of material that are used to make the sleeves, the zipper sleeve of the invention is manufactured in such a way that the zipper teeth rows are attached directly to each side of the sheet, thereby obviating the need to separately manufacture or purchase zippers and sew them onto the sides of the sheets.

The former known manufacturing process is relatively expensive to perform. A typical open-ended zipper of the type normally used in zipper sleeves includes first and second strips of tape having first and second zipper teeth rows attached thereto, respectively, an insertion pin attached to a first end of the first zipper teeth row, a retainer box attached to a first end of the second zipper teeth row, first and second stops attached to second ends of the first and second zipper teeth rows, respectively, and a slider slidingly engaged with the second zipper teeth row in between the retainer box and the stop. The processes of attaching the zipper teeth rows to the strips of tape, attaching the stops to the zipper teeth rows, attaching the retainer box to the first end of the second zipper teeth row, and attaching the insertion pin to the first end of the first zipper teeth row require multiple machines and some human operator involvement. For these reasons, open-ended zippers that are used in zipper sleeves are typically relatively expensive. The relatively high cost of the open-ended zippers contributes significantly to the high overall cost of zipper sleeves.

Furthermore, the known process by which the tape strips of the zippers are sewn onto the sides of the sheets requires that great care be taken to ensure that the first and second zipper teeth rows are precisely aligned with one another. Because this is relatively difficult to do, the zippers of the zipper sleeves will not always work properly, resulting in lower manufacturing yield and increasing the costs.

By attaching the zipper teeth rows directly to the meta-aramid material, in accordance with embodiments described herein, the cost associated with separately purchasing open-ended zippers is avoided. In addition, the process of attaching the zipper teeth rows to the sheet can be fully automated, which ensures that the teeth in opposing teeth rows will be precisely aligned. This feature of the invention allows a highly flame-retardant zipper sleeve made entirely or almost entirely out of meta-aramid material to be manufactured at relatively low costs, with very high precision and with very high yield. Illustrative embodiments of the zipper sleeve and of the manufacturing process will now be described with reference to the figures, in which like reference numerals represent like features, elements or components. It should be noted that features in the drawings are not drawn to scale.

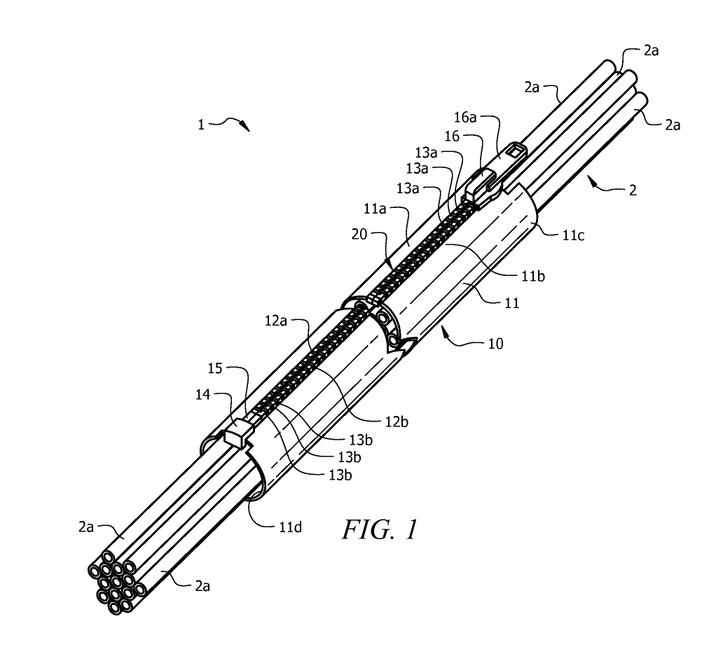

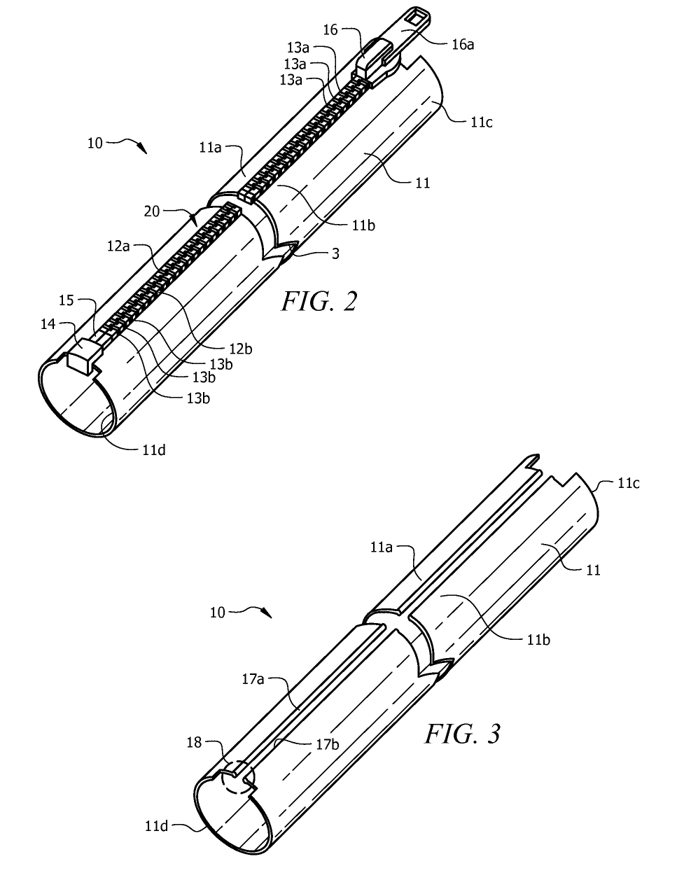

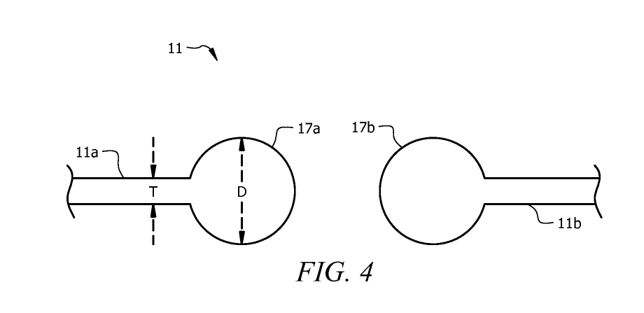

FIG. 1 illustrates a perspective view of a wrapped optical fiber cable bundle 1 in accordance with an illustrative embodiment. The wrapped cable bundle 1 comprises the zipper sleeve 10 of the present invention and an optical fiber cable bundle 2 wrapped in the zipper sleeve 10. The zipper sleeve 10 comprises a sheet 11 that is made entirely or almost entirely of meta-aramid fiber, which is highly flame retardant, and a zipper mechanism 20. The optical fiber cable bundle 2 comprises a plurality of optical fiber cables 2a, each of which comprises one or more optical fibers (not shown). FIG. 2 illustrates a perspective view of the zipper sleeve 10 shown in FIG. 1 without the optical fiber cable bundle 2. FIG. 3 illustrates a perspective view of the zipper sleeve 10 shown in FIG. 2 with the components that make up the zipper mechanism 20 removed. FIG. 4 illustrates an expanded side plan view of the portion of the sheet 11 inside of the dashed circle 18 shown in FIG. 3.

With reference to FIGS. 1 and 2, the sheet 11 of the zipper sleeve 10 has first and second sides 11a and 11b, a top 11c, and a bottom 11d. First and second zipper teeth rows 12a and 12b are directly secured to the first and second sides 11a and 11b, respectively, of the sheet 11. The first and second zipper teeth rows 12a and 12b comprise first and second rows of teeth 13a and 13b, respectively. The teeth 13a of row 12a are evenly spaced and the teeth 13b of row 12b are evenly spaced. The teeth 13a are precisely aligned with the teeth 13b so that the teeth 13a of row 12a interleave with the respective teeth 13b of row 12b when the zipper sleeve 10 is zipped to mesh the teeth rows 12a and 12b together. The zipper teeth row 12b includes a retainer box 14 that is attached to the sheet 11 near the bottom lid of the sheet 11. The zipper teeth row 12a includes a pin 15 that is secured to the sheet 11 near the bottom lid of the sheet 11 opposite the retainer box 14.

A slider 16 having a pull tab 16a is mechanically coupled to the zipper teeth rows 12a and 12b by a Y-channel (not shown) located inside of the slider 16 having respective grooves (not shown) that receive the respective zipper teeth rows 12a and 12b. The engagement of the Y-channel of the slider 16 with the teeth rows 12a and 12b allows the slider 16 to move in directions away from the bottom lid of the strip 11 toward the top 11c of the strip 11 to mesh (i.e., zip) the zipper teeth rows 12a and 12b together and to move in directions away from the top 11c of the strip 11 toward the bottom lid of the strip 11 to disengage (i.e., unzip) the zipper teeth rows 12a and 12b. The zipper teeth rows 12a and 12b are terminated near the top 11c of the sheet 11 by respective slider stops (not shown) to prevent the slider 16 from disengaging the zipper teeth rows 12a and 12b. The components 12a-16 together make up the zipper mechanism 20. The zipper mechanism 20 operates in the typical manner to join and unjoin parts. The zipper mechanism 20 is typically made of metal parts, but could be made of other suitable materials that have high flame-retardant characteristics and that have other desired or necessary mechanical characteristics to carry out their respective functions.

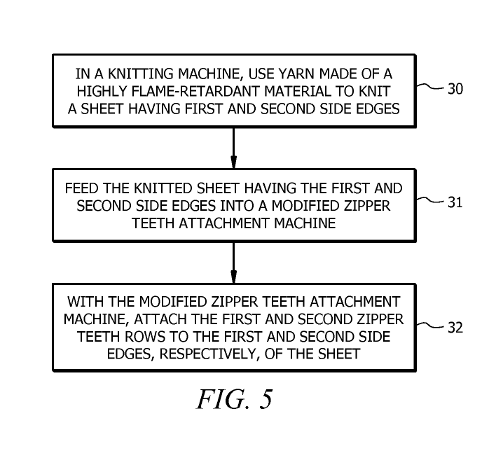

As indicated above, one of the unique features of the zipper sleeve 10 is that the zipper teeth rows 12a and 12b are attached directly onto the sides 11a and 11b, respectively, of the meta-aramid sheet 11. As discussed above, this is not the case with known zipper sleeves. In accordance with the present invention, the process of making the zipper sleeve 10 can be entirely automated, as will be described with reference to FIG. 5. The sides 11a and 11b of the sheet 11 have rounded edges 17a and 17b integrally formed thereon, respectively. The rounded edges 17a and 17b are generally circular in cross-section, but could have other cross-sections (e.g., rectangular). The first and second zipper teeth rows 12a and 12b (FIG. 2) are sewn directly onto these rounded edges 17a and 17b, respectively. Although features in the figures are not drawn to scale, in FIG. 4 it can be seen that the thickness, T, of the sheet 11 is smaller than the diameter, D, of the rounded edges 17a and 17b. The diameter D is greater than the thickness T to provide an enlarged area on the sides 11a and 11b of the sheet 11 for attachment of the zipper teeth rows 12a and 12b (FIGS. 1 and 2), respectively.

It is not necessary for the rounded edges 17a and 17b to be circular in cross-section, but the edges of the sides 11a and 11b need to be sufficiently thick to enable the zipper teeth rows 12a and 12b to be attached to them and to also prevent the sleeve 10 from tearing due to the forces exerted by the slider 16 (FIGS. 1 and 2). If the edges 17a and 17b have non-circular cross-sections, the edges 17a and 17b have thicknesses that are greater than the thickness of the sheet 11.

The material of which the sheet 11 is made may be, for example, Nomex® IIIA material, which is composed of 93% Nomex® meta-aramid fiber, 5% Kevlar® fiber and 2% antistatic fiber. Other types of meta-aramid materials may be used for this purpose, including, but not limited to other types of Nomex® meta-aramid materials.

FIG. 5 illustrates a flow diagram that demonstrates the method of making the highly flame-retardant zipper sleeve in accordance with an illustrative embodiment. For illustrative purposes, the method will be described with reference to fabricating a single zipper sleeve 10 (FIG. 1), although it should be noted that the method could be used to manufacture multiple zipper sleeves 10. The manufacturer of the zipper sleeve 10 obtains the yarn of which the sheet 11 is to be made from a supplier. The yarn is then used by a knitting machine to knit a sheet 11, including the side edges 17a and 17b, as indicated by block 30. The sheet 11 is then fed into a modified zipper teeth attachment machine (not shown), as indicated by block 31. The modified zipper teeth machine then attaches the first and second zipper teeth rows to the first and second side edges, respectively, as indicated by block 32. This completes the main portions of the zipper sleeve manufacturing process. The processes for installing the insertion pin, the retainer box, the stops, and the slider may be performed in the conventional manner.

The modified zipper teeth attachment machine is configured to accept the sheet 11, which is typically much wider than the strips of tape used in known open-ended zippers. The known zipper teeth attachment machine is configured to attach one zipper teeth row to one strip of tape at a time. The modified zipper teeth attachment machine is configured to receive the wider sheet 11 and to simultaneously attach the first and second zipper teeth rows 12a and 12b to the first and second side edges 17a and 17b, respectively, of the sheet 11. This latter feature ensures that the teeth 13a and 13b of the first and second zipper teeth rows, respectively, are precisely aligned with one another. It should be noted, however, that it is not necessary for the first and second zipper teeth rows 12a and 12b to be attached simultaneously to the first and second side edges 17a and 17b, respectively.

The entire process described above with reference to FIG. 5 can be, but is not required to be, fully automated, which ensures precision alignment of the teeth 13a and 13b, eliminates the potential for human error, and improves manufacturing yield. The combination of all of these features greatly reduces the overall cost of the highly flame-retardant zipper sleeve 10.

It should be noted that the invention has been described with reference to the illustrative embodiments in order to demonstrate the principles and concepts of the invention. Persons of skill in the art will understand, in view of the description provided herein, that many modifications may be made to the embodiments described herein without deviating from the principles, concepts and goals of the invention, and all such modifications are within the scope of the invention.

1. A highly flame-retardant zipper sleeve for wrapping a bundle of cables, the zipper sleeve comprising:
a sheet of highly flame-retardant material, the sheet having first and second sides, a top, and a bottom; and
a zipper mechanism, the zipper mechanism having first and second zipper teeth rows that are directly attached to first and second side edges, respectively, of the first and second sides of the sheet, respectively, the first and second zipper teeth rows having first and second rows of teeth, respectively, the first zipper teeth row having a first end and a second end, the first zipper teeth row having a pin located at the first end thereof, the second zipper teeth row having a first end and a second end, the first end of the second zipper teeth row having a retainer box located at the first end thereof, the second zipper teeth row having a slider of the zipper mechanism mechanically coupled thereto via a Y-channel of the slider, the slider being in sliding engagement with the second row of teeth.

2. The highly flame-retardant zipper sleeve of claim 1, wherein the first and second side edges are thicker than a thickness of the sheet, and wherein the first and second zipper teeth rows are directly attached to the first and second side edges, respectively, of the first and second sides of the sheet, respectively.

3. The highly flame-retardant zipper sleeve of claim 1, wherein the first and second edges are rounded and have a diameter that is greater than the thickness of the sheet.

4. The highly flame-retardant zipper sleeve of claim 1, wherein the highly flame-retardant material is entirely made of meta-aramid fibers.

5. The highly flame-retardant zipper sleeve of claim 1, wherein the highly flame-retardant material is made mostly or entirely of meta-aramid fibers.

6. The highly flame-retardant zipper sleeve of claim 5, wherein the highly flame-retardant material is made of approximately 93% meta-aramid fiber, approximately 5% Kevlar® fiber and approximately 2% antistatic fiber.

7. The highly flame-retardant zipper sleeve of claim 5, wherein the zipper mechanism is made of metal.

8. The highly flame-retardant zipper sleeve of claim 5, wherein the zipper mechanism is made of a hard, non-metallic, flame-retardant material.

9. The highly flame-retardant zipper sleeve of claim 5, wherein the first zipper teeth row has a stop located at the second end thereof, and wherein the second zipper teeth row has a stop located at the second end thereof.

10. A highly flame-retardant zipper sleeve for wrapping a bundle of cables, the zipper sleeve comprising:
a sheet of highly flame-retardant material, wherein the highly flame-retardant material is made mostly of meta-aramid fibers, the sheet having first and second sides, a top, and a bottom, the first and second sides having first and second side edges knitted therein, respectively, wherein the first and second side edges are thicker than a thickness of the sheet; and
a zipper mechanism, the zipper mechanism having first and second zipper teeth rows that are directly attached to the first and second side edges, respectively, of the first and second sides of the sheet, respectively, the first and second zipper teeth rows having first and second rows of teeth, respectively, the first zipper teeth row having a first end and a second end, the first zipper teeth row having a pin located at the first end thereof, the second zipper teeth row having a first end and a second end, the first end of the second zipper teeth row having a retainer box located at the first end thereof, the second zipper teeth row having a slider of the zipper mechanism mechanically coupled thereto via a Y-channel of the slider, the slider being in sliding engagement with the second row of teeth.

11. The highly flame-retardant zipper sleeve of claim 10, wherein the highly flame-retardant material is made of approximately 93% meta-aramid fiber, approximately 5% Kevlar® fiber and approximately 2% antistatic fiber.

12. A method of making a highly flame-retardant zipper sleeve comprising:
in a knitting machine, using highly flame retardant yarn to knit a sheet having first and second side edges;
feeding the knitted sheet having first and second side edges into a modified zipper teeth attachment machine; and
in the modified zipper teeth attachment machine, directly attaching first and second zipper teeth rows of a zipper mechanism to the first and second side edges, respectively, of the sheet, wherein the first and second zipper teeth rows have first and second rows of teeth, respectively, the first zipper teeth row having a first end and a second end, the first zipper teeth row having a pin located at the first end thereof, the second zipper teeth row having a first end and a second end, the first end of the second zipper teeth row having a retainer box located at the first end thereof, the second zipper teeth row having a slider of the zipper mechanism mechanically coupled thereto via a Y-channel of the slider, the slider being in sliding engagement with the second row of teeth.

13. The method of claim 12, wherein the first and second side edges are thicker than a thickness of the sheet.

14. The method of claim 12, wherein the first and second side edges are rounded and have a diameter that is greater than the thickness of the sheet.

15. The method of claim 12, wherein the highly flame-retardant yarn is meta-aramid yarn.

16. The method of claim 12, wherein the highly flame-retardant yarn is mostly or entirely meta-aramid yarn.

17. The method of claim 16, wherein the highly flame-retardant yarn is approximately 93% meta-aramid fiber, approximately 5% Kevlar® fiber and approximately 2% antistatic fiber.

18. The method of claim 16, wherein the zipper mechanism is made of metal.

19. The method of claim 16, wherein the zipper mechanism is made of a hard, non-metallic, flame-retardant material.

20. The method of claim 16, wherein the first zipper teeth row has a stop located at the second end thereof, and wherein the second zipper teeth row has a stop located at the second end thereof.

21. The method of claim 12, wherein the modified zipper attachment machine simultaneously directly attaches the first and second zipper teeth rows to the first and second side edges, respectively, of the sheet.
